(19) United States
(12) Patent Application Publication
(10) Pub. No.: US 2023/0179566 A1
(43) Pub. Date: Jun. 8, 2023

(54) Method and Device for Switching Internet Access mode of Gateway Device

(71) Applicant: TP-Link Corporation Limited, Hong Kong (CN)

(72) Inventor: Simeng CAO, Shenzhen (CN)

(21) Appl. No.: 18/074,537

(22) Filed: Dec. 5, 2022

(30) Foreign Application Priority Data
Dec. 7, 2021 (CN) 202111489272.9

(51) Int. Cl. H04L 61/4511; H04W 36/24; H04W 36/00

(52) U.S. Cl. CPC H04L 61/4511; H04W 36/24; H04W 36/0022; H04L 2101/30

(57) ABSTRACT

The present disclosure provides a method and a device for switching an Internet access mode of a gateway device. The method includes that: a DNS detection domain name is acquired, the DNS detection domain name being a predefined domain name; at least according to the DNS detection domain name, it is determined whether an EWAN connection is online, the EWAN connection being a network connection of the gateway device in an EWAN mode; and in a case that the EWAN connection is offline, the Internet access mode of the gateway device is switched to an LTE mode.

### TECHNICAL FIELD

The present disclosure relates to the technical field of communications technology, and in particular to a method and a device for switching an Internet access mode of a gateway device, a computer readable storage medium, and an intelligent switching system.

### BACKGROUND

With the development of mobile communication technology, more and more gateway devices support dial-up Internet access using multiple Internet access modes. Generally, an end user needs to manually set the Internet access mode of the gateway device. If the current Internet access mode of the gateway device cannot access the Internet, the end user needs to manually change the Internet access mode, which not only complicates the operation, but also leads to poor experience of the end user.

It is to be learned by an inventor that, although the intelligent switching of Internet access modes has been realized in the related art, the condition for judging whether it is necessary to switch the Internet access mode is relatively simple, all cases cannot be covered, and a case that the end user cannot access the Internet due to the failure to switch the modes in time can occur. In addition, in the current switching method, the problem of IPV6 connection is not considered, which can cause troubles to a user who uses the IPV6 connection to access the Internet.

Therefore, there is an urgent need for a method to accurately judge whether an Ethernet Wide Area Network (EWAN) connection in various cases is online.

The above information disclosed in the background section is only used to enhance the understanding of the background of the technology described herein. Therefore, the background can contain some information, which does not form the conventional art known in China for those skilled in the art.

### SUMMARY

According to an aspect of the embodiments of the disclosure, a method for switching an Internet access mode of a gateway device is provided, which include that: a DNS detection domain name is acquired, the DNS detection domain name being a predefined domain name; at least according to the DNS detection domain name, it is determined whether an EWAN connection is online, the EWAN connection being a network connection of the gateway device in an EWAN mode; and in a case that the EWAN connection is offline, the Internet access mode of the gateway device is switched to an LTE mode.

In some alternative embodiments, the operation of determining whether the EWAN connection is online at least according to the DNS detection domain name include that: it is determined whether connection of dial-up Internet access using at least one of Internet Protocols is offline at least according to the DNS detection domain name; and in a case that the connection of the dial-up Internet access using at least one of the Internet Protocols is offline, the EWAN connection is determined to be offline.

In some alternative embodiments, the operation of determining whether the connection of the dial-up Internet access using at least one of the Internet Protocols is offline at least according to the DNS detection domain name include that: based on the IP, the DNS detection domain name is sent to a DNS; in a case that the DNS detection domain name is resolved in the DNS, it is determined that the connection of the dial-up Internet access using the IP is online; and in a case that the DNS detection domain name is not resolved in the DNS, it is determined that the connection of the dial-up Internet access using the IP is offline.

In some alternative embodiments, the operation of determining whether the connection of the dial-up Internet access using at least one of the Internet Protocols is offline at least according to the DNS detection domain name include that: a preset IP address is acquired; based on the IP, the DNS detection domain name is sent to a DNS; in a case that the DNS detection domain name is resolved in the DNS and the preset IP address is reachable, it is determined that the connection of the dial-up Internet access using the IP protocol is online; and in a case that that at least one of following conditions is met: the DNS detection domain name is not resolved in the DNS, the preset IP address is unreachable, it is determined that the connection of the dial-up Internet access using the IP is offline.

In some alternative embodiments, in a case that performing the dial-up Internet access through multiple of the Internet Protocols at the same time, the operation of determining whether the EWAN connection is offline in the case that the connection of the dial-up Internet access using at least one of the Internet Protocols is offline include that: it is determined whether the EWAN connection is offline in a case that the connection of the dial-up Internet access using all of the Internet Protocols is offline.

In some alternative embodiments, after the Internet access mode of the gateway device is switched to the LTE mode, the method further include that: request information is sent every predetermined time, and it is determined whether the EWAN connection is online again, the request information being used for requesting connection to the EWAN connection; and in a case that the EWAN connection is online, the LTE mode is exited, and the Internet access mode of the gateway device is switched to the EWAN mode.

In some alternative embodiments, the operation of determining whether the EWAN connection is online include that: it is determined that the EWAN connection is online in the case that the connection of the dial-up Internet access using at least one of the Internet Protocols is online.

According to another aspect of the embodiments of the disclosure, a device for switching an Internet access mode of a gateway device is provided, which include: an acquisition component, configured to acquire a DNS detection domain name, the DNS detection domain name being a predefined domain name; a determination component, configured to determine whether an EWAN connection is online at least according to the DNS detection domain name, the EWAN connection being a network connection of the gateway device in an EWAN mode; and a switching component, configured to switch the Internet access mode of the gateway device to an LTE mode in a case that the EWAN connection is offline.

According to yet another aspect of the embodiments of the disclosure, a computer readable storage medium is further provided. The computer readable storage medium includes a program which is stored, and the program executes any above-mentioned method.

According to still another aspect of the embodiments of the disclosure, an intelligent switching system is further provided, which include: a gateway device, one or more processors, a memory and one or more programs, and the one or more programs are stored in the memory and configured to be executed by the one or more processors, and the one or more programs include being configured to execute any above-mentioned method.

### BRIEF DESCRIPTION OF THE DRAWINGS

The drawings consisting a part of the present disclosure are used to provide further understanding of the present disclosure. The schematic embodiments of the present disclosure and description thereof are used for explaining the present disclosure and do not limit the present disclosure improperly. In the drawings,

FIG. 1 illustrates a schematic diagram of a method for switching an Internet access mode of a gateway device according to an embodiment of the present disclosure.

FIG. 2 illustrates a schematic diagram of a device for switching an Internet access mode of a gateway device according to an embodiment of the present disclosure.

FIG. 3 illustrates a detection logic diagram according to an embodiment of the present disclosure.

FIG. 4 illustrates a single or dual detection logic diagram according to an embodiment of the present disclosure.

### DETAILED DESCRIPTION OF THE EMBODIMENTS

It is to be noted that the embodiments of the present disclosure and the features in the embodiments can be combined with each other without conflict. The present disclosure will be described in detail with reference to the accompanying drawings and embodiments.

In order to enable those skilled in the art to better understand the solutions of the present disclosure, the technical solutions in the embodiments of the present disclosure will be clearly and completely described below in combination with the drawings in the embodiments of the present disclosure, and it is apparent that the described embodiments are only a part rather all of embodiments of the present disclosure. All other embodiments obtained by those of ordinary skill in the art based on the embodiments in the present disclosure without creative work shall fall within the scope of protection of the present disclosure.

It is to be noted that terms “first”, “second”, etc., in the specification, claims, and drawings of the present disclosure are adopted not to describe a specific sequence or order but to distinguish similar objects. It is to be understood that data used like this can be interchanged as appropriate such that the embodiments of the present disclosure described here can be implemented. In addition, terms “comprise”, “comprising”, “include”, “including”, “has”, “having” or any other variations thereof, are intended to cover a non-exclusive inclusion. For example, a process, method, system, product or device that includes a list of steps or components is not necessarily limited to only those steps or components but can include other steps or components not expressly listed or inherent to such process, method, product or device.

As mentioned in the background, it is difficult to accurately judge whether an EWAN connection in various cases is online in the related art. To solve the above problem, a typical implementation mode of the present disclosure provides a method and a device for switching an Internet access mode of a gateway device, a computer readable storage medium and an intelligent switching system.

According to the embodiment of the present disclosure, a method for switching an Internet access mode of a gateway device is provided.

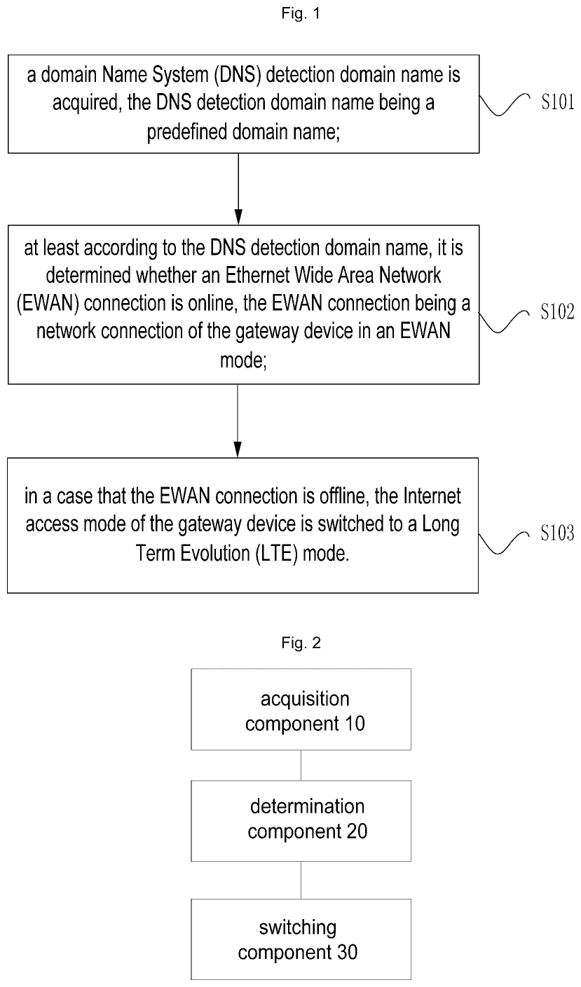

FIG. 1 is a flowchart of the method for switching the Internet access mode of the gateway device according to an embodiment of the present disclosure. As shown in FIG. 1, the method includes the following steps:

Step S101, a Domain Name System (DNS) detection domain name is acquired, the DNS detection domain name being a predefined domain name;

Step S102, at least according to the DNS detection domain name, it is determined whether an Ethernet Wide Area Network (EWAN) connection is online, the EWAN connection being a network connection of the gateway device in an EWAN mode;

Step S103, in a case that the EWAN connection is offline, the Internet access mode of the gateway device is switched to a Long Term Evolution (LTE) mode.

In the method for switching the Internet access mode of the gateway device, the DNS detection domain name is first acquired. Then, at least according to the acquired DNS detection domain name, it is determined whether the EWAN connection is online. Finally, the Internet access mode of the gateway device is switched to the LTE mode in the case that the EWAN connection is determined to be offline. And the DNS detection domain name is the predefined domain name, and the EWAN connection is the network connection of the gateway device in the EWAN mode. Compared with the related art, whether the Internet access mode is switched to the LTE mode is determined by detecting whether a network cable is plugged into a WAN port, the solution realizes that whether the EWAN connection is online is determined at least according to the acquired DNS detection domain name. That is, at least according to the DNS detection domain name, the EWAN connection established by each Internet Protocol (IP) can be detected, which ensures that whether the EWAN connection is online can be effectively determined, and can more accurately detect whether the EWAN connection in all cases is online. In the case that it is determined that the EWAN connection is offline, the Internet access mode of the gateway device is switched to the LTE mode, so that intelligent switching of the Internet access mode of the gateway device is realized, and the continuity of the terminal user device network is ensured, thereby solving the problem that it is difficult to accurately judge whether the EWAN connection in all cases is online in the related art.

In an actual application process, the gateway device can be a router, but is not limited to a router, and can also be another gateway device. In addition, the above IP can be an Internet Protocol Version 4 (IPv4) or an Internet Protocol Version 6 (IPv6).

In addition, it is to be noted that the above DNS detection domain name can be a user-defined detection domain name.

It should be noted that the steps presented in the flowchart of the drawings can be executed in a computer system like a group of computer executable instructions, and moreover, although a logical order is shown in the flow chart, in some cases, the presented or described steps can be performed in an order different from that described here.

In order to effectively and timely determine whether the EWAN connection is online, in one embodiment of the present disclosure, the operation of determining whether the EWAN connection is online at least according to the DNS detection domain name includes that: it is determined whether the connection of dial-up Internet access using at least one of Internet Protocols is offline at least according to the DNS detection domain name; and in a case that the connection of the dial-up Internet access using at least one of the Internet Protocols is offline, it is determined whether the EWAN connection is offline.

In an actual application process, if the Internet access mode of the gateway device is an EWAN mode, in the EWAN mode, if the gateway device establishes an Internet connection through an IPv4, whether the EWAN connection is offline can be judged at least according to the DNS detection domain name. If the gateway device establishes an Internet connection through an IPv6, whether the EWAN connection is offline can be judged at least according to the DNS detection domain name. If the gateway device establishes an Internet connection through the IPv4 and IPv6, whether the EWAN connection is offline can be judged at least according to the DNS detection domain name.

In a specific embodiment of the present disclosure, in a case that the above-mentioned device establishes the Internet connection using the IPv4 or establishes the Internet connection using the IPv61, the gateway device can switch to LTE dial-up Internet access as long as the connection to the Internet using the IPv4 or the connection to the Internet using the IPv6 is offline. When the connection to the Internet using the IPv4 or the connection to the Internet using the IPv6 is restored online, the gateway device can disconnect the LTE dial-up Internet connection and restore to the EWAN connection.

In another embodiment of the present disclosure, the operation of determining whether the connection of the dial-up Internet access using at least one of the Internet Protocols is offline at least according to the DNS detection domain name includes that: based on the IP, the DNS detection domain name is sent to a DNS; in a case that the DNS detection domain name is resolved in the DNS, it is determined that the connection of the dial-up Internet access using the IP is online; and in a case that the DNS detection domain name is not resolved in the DNS, it is determined that the connection of the dial-up Internet access using the IP is offline. In the embodiment, whether the connection of the dial-up Internet access using the IP is online is determined according to whether the DNS detection domain name is resolved in the DNS, which ensures that the method for determining whether the connection of the dial-up Internet access using the IP is offline is flexible and can timely determine whether the connection of the dial-up Internet access using the IP is online.

In an actual application process, when the gateway device can support single detection, that is, a user customizes the DNS detection domain name, and in a case that the gateway device can resolve the DNS detection domain name from the DNS, it is considered that the established EWAN connection is online.

In order to accurately determine whether the connection of the dial-up Internet access using the IP is offline or not, and further ensure the continuity of the end user device network, in another embodiment of the present disclosure, the operation of determining whether the connection of the dial-up Internet access using at least one of the Internet Protocols is offline at least according to the DNS detection domain name includes that: a preset IP address is acquired; based on the IP, the DNS detection domain name is sent to a DNS; in a case that the DNS detection domain name is resolved in the DNS and the preset IP address is reachable, it is determined that the connection of the dial-up Internet access using the IP is online; and in a case that at least one of following conditions is met: the DNS detection domain name is not resolved in the DNS, the preset IP address is unreachable, it is determined that the connection of the dial-up Internet access using the IP is offline. That is, in the case that the DNS detection domain name is not resolved in the DNS and the preset IP address is unreachable, or in the case that the DNS detection domain name is not resolved in the DNS, or in the case that the preset IP address is unreachable, it is determined that the connection of dial-up Internet access using the IP protocol is offline.

It is to be noted that the above-mentioned preset IP address can be any IP address input by the user, which only needs to be applicable to Ping IP (used to send ICMP request to this IP address and get ICMP reply from this IP address) to detect the connectivity of the network.

In an actual application process, when the gateway device can support dual detection, the user can customize the DNS detection domain name and Ping IP address. When the gateway device can resolve the DNS detection domain name from the DNS and the customized IP address is pingable, it is considered that the EWAN connection is online; otherwise, it is considered that the EWAN connection is offline.

In addition, the single detection method and the dual detection method can allow a user to flexibly customize the offline condition of the EWAN connection, and when the front end of the gateway device is disconnected, but there is a DNS cache or a DNS proxy, the connection is considered to be online by employing the single DNS detection, but by employing the dual DNS+ping detection, the network can be judged to be offline and can be switched to the LTE mode for Internet access, thus ensuring the continuity of the end user device network.

In yet another embodiment of the present disclosure, in a case that performing the dial-up Internet access through multiple of the Internet Protocols at the same time, the operation of determining whether the EWAN connection is offline in the case that the connection of the dial-up Internet access using at least one of the Internet Protocols is offline includes that: it is determined whether the EWAN connection is offline in a case that the connection of the dial-up Internet access using all of the Internet Protocols is offline. In the embodiment, during performing the dial-up Internet access using multiple Internet Protocols, when the connection of the dial-up Internet access using all of the Internet Protocols is determined to be offline, the EWAN connection is determined to be offline, which not only further ensures that the determination result of EWAN connection being offline is more accurate, but also further ensures that the traffic charges of the user can be reduced as much as possible.

In a specific embodiment of the present disclosure, when the above gateway device uses IPV4 and IPV6 to establish Internet connection, the above gateway device switches to LTE dial-up Internet access only in a case that both the Internet connection established by the IPV4 and the Internet connection established by the IPV6 are offline. In a case that any one of the connections comes back online, the gateway device disconnects the LTE dial-up Internet access and restore to the EWAN connection.

In order to ensure that the traffic charges can be consumed as little as possible, in one embodiment of the present disclosure, after the Internet access mode of the gateway device is switched to the LTE mode, the method further includes that: request information is sent every predetermined time, and it is determined whether the EWAN connection is online again, the request information being used for requesting connection to the EWAN connection; and in a case that the EWAN connection is online, the LTE mode is exited, and the Internet access mode of the gateway device is switched to the EWAN mode. In the embodiment, after the Internet access mode of the gateway device is switched to the LTE mode, the EWAN connection can be reconnected regularly and whether the EWAN connection is online is detected, which not only further ensures uninterrupted network service for the user terminal device, but also reduces the traffic charges of the user terminal device.

In order to further ensure that the traffic charges can be consumed as little as possible, in another embodiment of the present disclosure, the operation of determining whether the EWAN connection is online includes that: it is determined that the EWAN connection is online in the case that the connection of the dial-up Internet access using at least one of the Internet Protocols is online.

The embodiment of the present disclosure also provides a device for switching an Internet access mode of a gateway device. It is to be noted that the device for switching the Internet access mode of the gateway device of the embodiment of the present disclosure can be configured to implement the method for switching the Internet access mode of the gateway device provided by the embodiment of the present disclosure. An introduction is made below to the device for switching the Internet access mode of the gateway device provided by the embodiment of the present disclosure.

FIG. 2 is a schematic diagram of the device for switching the Internet access mode of the gateway device according to an embodiment of the present disclosure. As shown in FIG. 2, the device includes:

an acquisition component 10, configured to acquire a DNS detection domain name, the DNS detection domain name being a predefined domain name;

a determination component 20, configured to determine whether an EWAN connection is online at least according to the DNS detection domain name, the EWAN connection being a network connection of the gateway device in an EWAN mode;

a switching component 30, configured to switch the Internet access mode of the gateway device to an LTE mode in a case that the EWAN connection is offline.

In the device for switching the Internet access mode of the gateway device, the acquisition component is configured to acquire the DNS detection domain name, the DNS detection domain name is the predefined DNS domain name; the determination component is configured to determine, at least according to the DNS detection domain name, whether the EWAN connection is online, the EWAN connection is the network connection of the gateway device in the EWAN mode; the switching component is configured to switch, in the case that the EWAN connection is offline, the Internet access mode of the gateway device to the LTE mode. Compared with the related art, whether the Internet access mode is switched to the LTE mode is determined by detecting whether a network cable is plugged into a WAN port, the solution realizes that whether the EWAN connection is online is determined at least according to the acquired DNS detection domain name. That is, at least according to the DNS detection domain name, the EWAN connection established by each IP can be detected, which ensures that whether the EWAN connection is online can be effectively determined, and can more accurately detect whether the EWAN connection in all cases is online. In the case that it is determined that the EWAN connection is offline, the Internet access mode of the gateway device is switched to the LTE mode, so that intelligent switching of the Internet access mode of the gateway device is realized, and the continuity of the terminal user device network is ensured, thereby solving the problem that it is difficult to accurately judge whether the EWAN connection in all cases is online in the related art.

In an actual application process, the gateway device can be a router, but is not limited to a router, and can also be another gateway device. In addition, the above IP can be an IPV4 or an IPV6.

In addition, it is to be noted that the above DNS detection domain name can be a user-defined detection domain name.

In order to effectively and timely determine whether the EWAN connection is online, in one embodiment of the present disclosure, the determination component includes a first determination module and a second determination module, and the first determination module is configured to determine whether the connection of dial-up Internet access using at least one of Internet Protocols is offline at least according to the DNS detection domain name; and the second determination module is configured to determine whether the EWAN connection is offline in a case that the connection of the dial-up Internet access using at least one of the Internet Protocols is offline.

In an actual application process, if the Internet access mode of the gateway device is an EWAN mode, in the EWAN mode, if the gateway device establishes an Internet connection through an IPV4, whether the EWAN connection is offline can be judged at least according to the DNS detection domain name. If the gateway device establishes an Internet connection through an IPV6, whether the EWAN connection is offline can be judged at least according to the DNS detection domain name. If the gateway device establishes an Internet connection through the IPV4 and IPV6, whether the EWAN connection is offline can be judged at least according to the DNS detection domain name.

In a specific embodiment of the present disclosure, in a case that the above-mentioned device establishes the Internet connection using the IPV4 or establishes the Internet connection using the IPV6, the gateway device can switch to LTE dial-up Internet access as long as the connection to the Internet using the IPV4 or the connection to the Internet using the IPV6 is offline. When the connection to the Internet using the IPV4 or the connection to the Internet using the IPV6 is restored online, the gateway device can disconnect the LTE dial-up Internet connection and restore to the EWAN connection.

In yet another embodiment of the present disclosure, the first determination module includes a first sending sub-module, a first determination sub-module and a second determination sub-module, and the first sending sub-module is configured to send, based on the IP, the DNS detection domain name to a DNS; the first determination sub-module is configured to determine the connection of the dial-up Internet access using the IP is online in a case that the DNS detection domain name is resolved in the DNS; the second determination sub-module is configured to determine that the connection of the dial-up Internet access using the IP is offline in a case that the DNS detection domain name is not resolved in the DNS. In the embodiment, whether the connection of the dial-up Internet access using the IP is online is determined according to whether the DNS detection domain name is resolved in the DNS, which ensures that the method for determining whether the connection of the dial-up Internet access using the IP is offline is flexible and can timely determine whether the connection of the dial-up Internet access using the IP is online.

In an actual application process, when the gateway device can support single detection, that is, a user customizes the DNS detection domain name, and in a case that the gateway device can resolve the DNS detection domain name from the DNS, it is considered that the established EWAN connection is online.

In order to accurately determine whether the connection of the dial-up Internet access using the IP protocol is offline or not, and further ensure the continuity of the end user device network, in another embodiment of the present disclosure, the first determination module includes an acquisition sub-module, a second sending sub-module, a third determination sub-module and a fourth determination sub-module, and the acquisition sub-module is configured to acquire a preset IP address; the second sending sub-module is configured to send, based on the IP, the DNS detection domain name to a DNS; the third determination sub-module is configured to determine that the connection of the dial-up Internet access using the IP is online in a case that the DNS detection domain name is resolved in the DNS and the preset IP address is reachable; the fourth determination sub-module is configured to determine that the connection of the dial-up Internet access using the IP is offline in a case that at least one of following conditions is met: the DNS detection domain name is not resolved in the DNS, the preset IP address is unreachable.

It is to be noted that the above-mentioned preset IP address can be any IP address input by the user, which only needs to be applicable to Ping IP to detect the connectivity of the network.

In an actual application process, when the gateway device can support dual detection, the user can customize the DNS detection domain name and Ping IP address. When the gateway device can resolve the DNS detection domain name from the DNS and ping the customized IP address, it is considered that the EWAN connection is online; otherwise, it is considered that the EWAN connection is offline.

In addition, the single detection method and the dual detection method can allow a user to flexibly customize the offline condition of the EWAN connection, and when the front end of the gateway device is disconnected, but there is a DNS cache or DNS proxy, the connection is considered to be online by employing the single DNS detection, but by employing the dual DNS+ping detection, the network can be judged to be offline and can be switched to the LTE mode for Internet access, thus ensuring the continuity of the end user device network.

In still another embodiment of the present disclosure, the second determination module includes a fifth determination sub-module, the fifth determination sub-module is configured to determine whether the EWAN connection is offline in a case that performing the dial-up Internet access through multiple of the Internet Protocols at the same time, and in a case that the connection of the dial-up Internet access using all of the Internet Protocols is offline. In the embodiment, during performing the dial-up Internet access using multiple Internet Protocols, when the connections of the dial-up Internet access using all of the Internet Protocols are determined to be offline, the EWAN connection is determined to be offline, which not only further ensures that the determination result of EWAN connection being offline is more accurate, but also further ensures that the traffic charges of the user can be reduced as much as possible.

In a specific embodiment of the present disclosure, when the above gateway device uses IPV4 and IPV6 to establish Internet connection, the above gateway device switches to LTE dial-up Internet access only when both the Internet connection established by the IPV4 and the Internet connection established by the IPV6 are offline. In a case that any one of the connections comes back online, the gateway device disconnects the LTE dial-up Internet access and restore to the EWAN connection.

In order to ensure that the traffic charges can be consumed as little as possible, in one embodiment of the present disclosure, the device further includes a sending component and a disconnection component, and the sending component is configured to send request information every predetermined time after the Internet access mode of the gateway device is switched to the LTE mode, and determine whether the EWAN connection is online again, the request information being used for requesting connection to the EWAN connection; the disconnection component is configured to exit, in a case that the EWAN connection is online, the LTE mode, and switch the Internet access mode of the gateway device to the EWAN mode. In the embodiment, after the Internet access mode of the gateway device is switched to the LTE mode, the EWAN connection can be reconnected regularly and whether the EWAN connection is online is detected, which not only further ensures uninterrupted network service for the user terminal device, but also reduces the traffic charges of the user terminal device.

In order to further ensure that the traffic charges can be consumed as little as possible, in another embodiment of the present disclosure, the determination component further includes a third determination module, configured to determine that the EWAN connection is online in the case that the connection of the dial-up Internet access using at least one of the Internet Protocols is online.

In order to enable those skilled in the art to have a clearer understanding of the technical solution of the present disclosure, the following description will be made with reference to specific examples:

### Embodiment 1

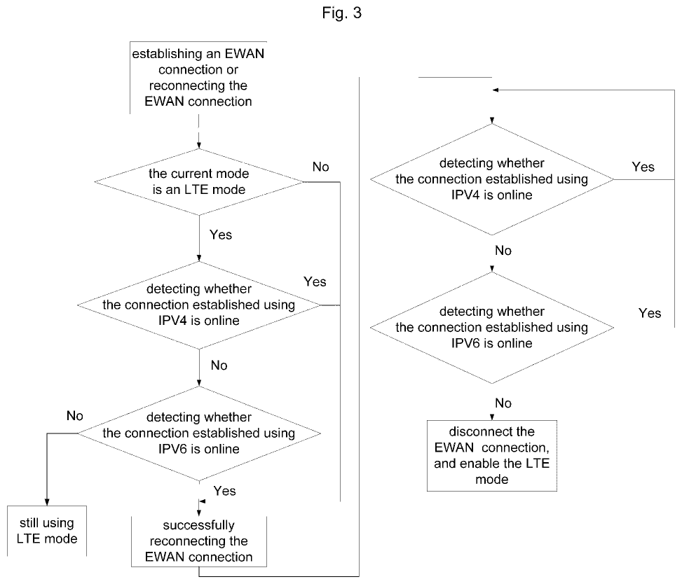

As shown in FIG. 3, the gateway device is provided with two Internet access modes: an LTE mode and an EWAN mode. When the gateway device is running in the EWAN mode, an EWAN connection can be established and whether the EWAN connection is online is regularly detected. If it is detected that the EWAN connection is offline, the gateway device can automatically switch to the LTE mode. When the gateway device switches to the LTE mode, the EWAN connection can be regularly reconnected and it is detected whether the EWAN connection is online. When it is confirmed that the EWAN connection is back online, the gateway device can automatically exit the LTE mode and switch back to the EWAN mode. The switching method of the intelligent Internet access mode can achieve the purpose of providing uninterrupted network service for a terminal device and at the same time consuming as little traffic charges as possible.

In addition, the method for switching the Internet access mode in the solution also supports the online detection of the IPV4, the online detection of the IPV6, and the online detection of the IPV4 and IPV6 in the EWAN mode. First, it is judged whether the current Internet access mode of the gateway device is the LTE mode. In a case that the current Internet access mode of the gateway device is the LTE mode, and the gateway device is connected using IPV4 or IPV6, it is detected whether the connection established using the IPV4 is online. In a case of determining that the connection established using the IPV4 is online, it is determined that the EWAN connection is successfully reconnected. In a case that the connection established using the IPV4 is not online, whether the connection established using the IPV6 is online or not is detected. In a case of detecting that the connection established using the IPV6 is online, it is determined that the EWAN connection is successfully reconnected. In a case of detecting that the connection established using the IPV6 is not online, the Internet access mode of the gateway device still adopts the LTE mode. That is, the solution realizes that the gateway device can still use the LTE mode to access the Internet as long as the Internet connection established using the IPV4 or the Internet connection established using the IPV6 is offline. In a case of successful reconnection of the EWAN connection, the terminal device can exit the LTE mode and resume to connect to the Internet using EWAN. In the case that the gateway device establishes the Internet connection using the IPV4 and IPV6, the gateway device can disconnect the EWAN connection and enable the LTE mode only when both the Internet connection established using the IPV4 and the Internet connection established using the IPV6 are offline. When any one of the connections comes back online, the gateway device can exit the LTE mode and resume to connect to the Internet using the EWAN.

### Embodiment 2

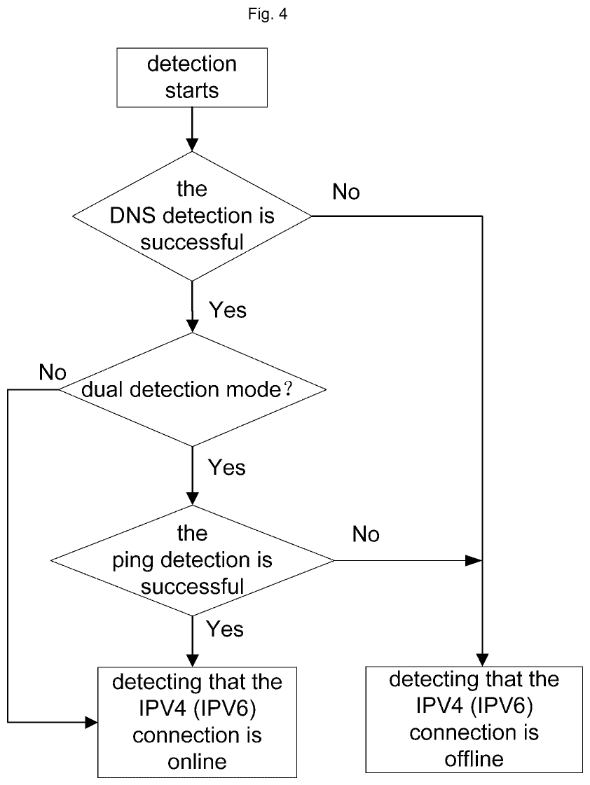

As shown in FIG. 4, in a case that the gateway device supports single detection and dual detection, when a user selects the single detection, the user can customize the DNS detection domain name. If the gateway device can resolve the address of the domain name from the DNS (that is, the DNS detection is successful), it is considered that the connection is online. When the user selects the dual detection, the user can customize the DNS detection domain name and ping IP address. If the gateway device can resolve the domain name address from the DNS and the customized IP address is pingable (that is, the Ping detection is successful), it is considered that the IPV4 (IPV6) connection detection is online; otherwise, it is considered that the IPV4 (IPV6) connection detection is offline. The above detection method can allow a user to flexibly customize the offline condition of the EWAN connection, and when the front end of the gateway device is disconnected, but there is a DNS cache or a DNS proxy, the connection is considered to be online by employing the single DNS detection, but by employing the dual DNS+ping detection, the network can be judged to be offline and switches to the LTE mode for Internet access, thus ensuring the continuity of the end user device network.

The device for switching the Internet access mode of the gateway device includes a processor and a memory. The above-mentioned acquisition component, the determination component, the switching component and the like are all stored in the memory as program components, and the above-mentioned program components stored in the memory are executed by the processor so as to implement the corresponding functions.

The processor includes a kernel, which can call the corresponding program component in the memory. One or more kernels can be set, and the problem in the related art that it is difficult to accurately judge whether the EWAN connection in all cases is online or not is solved by adjusting a kernel parameter.

The memory can include forms of a volatile memory in a computer-readable medium, a Random Access Memory (RAM) and/or a volatile memory and the like, such as a Read-Only Memory (ROM) or a flash RAM, and the memory includes at least one storage chip.

The embodiments of the disclosure provide a storage medium, on which a program is stored. When executed by a processor, the program implements the switching method for the Internet access mode of the gateway device.

The embodiments of the disclosure provide a processor. The processor is configured to run a program. Herein, when running, the program executes the switching method for the Internet access mode of the gateway device.

In a typical embodiment of the present disclosure, an intelligent switching system is further provided, which includes: a gateway device, one or more processors, a memory and one or more programs, and the one or more programs are stored in the memory and configured to be executed by the one or more processors, and the one or more programs include being configured to execute any above-mentioned switching method.

The intelligent switching system includes the gateway device, the one or more processors, the memory and the one or more programs, the intelligent switching system can execute any of the above-mentioned switching methods. In the switching method, the DNS detection domain name is first acquired. Then, at least according to the acquired DNS detection domain name, it is determined whether the EWAN connection is online. Finally, the Internet access mode of the gateway device is switched to the LTE mode in the case that the EWAN connection is determined to be offline. And the DNS detection domain name is the predefined DNS domain name, and the EWAN connection is the network connection of the gateway device in the EWAN mode. Compared with the related art, whether the Internet access mode is switched to the LTE mode is determined by detecting whether a network cable is plugged into a WAN port, the solution realizes that whether the EWAN connection is online is determined at least according to the acquired DNS detection domain name. That is, at least according to the DNS detection domain name, the EWAN connection established by each IP can be detected, which ensures that whether the EWAN connection is online can be effectively determined, and can more accurately detect whether the EWAN connection in all cases is online. In the case that it is determined that the EWAN connection is offline, the Internet access mode of the gateway device is switched to the LTE mode, so that intelligent switching of the Internet access mode of the gateway device is realized, and the continuity of the terminal user device network is ensured, thereby solving the problem that it is difficult to accurately judge whether the EWAN connection in all cases is online in the related art.

The embodiments of the disclosure provide a device, which includes a processor, a memory and a program stored on the memory and being capable of running on the processor. When the processor executes the program, at least the following steps are implemented.

Step S101, a DNS detection domain name is acquired, the DNS detection domain name being a predefined domain name;

Step S102, at least according to the DNS detection domain name, it is determined whether an EWAN connection is online, the EWAN connection being a network connection of the gateway device in an EWAN mode;

Step S103, in a case that the EWAN connection is offline, the Internet access mode of the gateway device is switched to an LTE mode.

The device herein can be a server, a Personal Computer (PC), a PAD, a mobile phone, etc.

The present disclosure further provides a computer program product, which is suitable for executing a program of initializing at least the following method steps when executed on a data processing device.

Step S101, a DNS detection domain name is acquired, the DNS detection domain name being a predefined domain name;

Step S102, at least according to the DNS detection domain name, it is determined whether an EWAN connection is online, the EWAN connection being a network connection of the gateway device in an EWAN mode;

Step S103, in a case that the EWAN connection is offline, the Internet access mode of the gateway device is switched to an LTE mode.

In the above-mentioned embodiments of the disclosure, the descriptions of each embodiment have their own emphasis, and the parts that are not detailed in one embodiment can be referred to the related descriptions of other embodiments.

In the several embodiments provided in the present disclosure, it is to be understood that the disclosed technical content can be implemented in other manners. The device embodiment described above is only schematic, and for example, division of the components is only logic function division, and other division manners can be adopted during practical implementation. For example, multiple components or components can be combined or integrated into another system, or some characteristics can be neglected or not executed. In addition, coupling or direct coupling or communication connection between each displayed or discussed component can be indirect coupling or communication connection, implemented through some interfaces, of the components or the modules, and can be electrical or adopt other forms.

The components described as separate parts can or can not be physically separate, and parts displayed as components can or can not be physical components, can be located in one position, or can be distributed on a plurality of components. Part or all of the components can be selected to achieve the purposes of the solutions of the embodiments according to a practical requirement.

In addition, each function component in each embodiment of the disclosure can be integrated into a processing component, or each component can exist independently, or two or more than two components can also be integrated into a component. The integrated component can be implemented in a hardware form and can also be implemented in form of software functional component.

When being implemented in form of software functional component and sold or used as an independent product, the integrated component can be stored in a computer-readable storage medium. Based on such an understanding, the technical solutions of the disclosure substantially or parts making contributions to the conventional art or all or part of the technical solutions can be embodied in form of software product. The computer software product is stored in a storage medium, including a plurality of instructions configured to enable a computer device (which can be a personal computer, a server, a network device, etc.) to execute all or part of the steps of the method in each embodiment of the disclosure. The above-mentioned storage medium includes: various media capable of storing program codes such as a U disk, a Read-Only Memory (ROM), a Random Access Memory (RAM), a mobile hard disk, a magnetic disk, or an optical disk.

It is to be seen from the above descriptions that the above-mentioned embodiments of the present disclosure have achieved the following technical effects.

1) In the method for switching the Internet access mode of the gateway device of the present disclosure, the DNS detection domain name is first acquired. Then, at least according to the acquired DNS detection domain name, it is determined whether the EWAN connection is online. Finally, the Internet access mode of the gateway device is switched to the LTE mode in the case that the EWAN connection is determined to be offline. And the DNS detection domain name is the predefined domain name, and the EWAN connection is the network connection of the gateway device in the EWAN mode. Compared with the related art, whether the Internet access mode is switched to the LTE mode is determined by detecting whether a network cable is plugged into a WAN port, the solution realizes that whether the EWAN connection is online is determined at least according to the acquired DNS detection domain name. That is, at least according to the DNS detection domain name, the EWAN connection established by each IP (Internet Protocol) can be detected, which ensures that whether the EWAN connection is online can be effectively determined, and can more accurately detect whether the EWAN connection in all cases is online. In the case that it is determined that the EWAN connection is offline, the Internet access mode of the gateway device is switched to the LTE mode, so that intelligent switching of the Internet access mode of the gateway device is realized, and the continuity of the terminal user device network is ensured, thereby solving the problem that it is difficult to accurately judge whether the EWAN connection in all cases is online in the related art.

2) In the device for switching the Internet access mode of the gateway device of the present disclosure, the acquisition component is configured to acquire the DNS detection domain name, the DNS detection domain name is the predefined DNS domain name; the determination component is configured to determine, at least according to the DNS detection domain name, whether the EWAN connection is online, the EWAN connection is the network connection of the gateway device in the EWAN mode; the switching component is configured to switch, in the case that the EWAN connection is offline, the Internet access mode of the gateway device to the LTE mode. Compared with the related art, whether the Internet access mode is switched to the LTE mode is determined by detecting whether a network cable is plugged into a WAN port, the solution realizes that whether the EWAN connection is online is determined at least according to the acquired DNS detection domain name. That is, at least according to the DNS detection domain name, the EWAN connection established by each IP can be detected, which ensures that whether the EWAN connection is online can be effectively determined, and can more accurately detect whether the EWAN connection in all cases is online. In the case that it is determined that the EWAN connection is offline, the Internet access mode of the gateway device is switched to the LTE mode, so that intelligent switching of the Internet access mode of the gateway device is realized, and the continuity of the terminal user device network is ensured, thereby solving the problem that it is difficult to accurately judge whether the EWAN connection in all cases is online in the related art.

3) The intelligent switching system of the present disclosure includes the gateway device, the one or more processors, the memory and the one or more programs, the intelligent switching system can execute any of the above-mentioned switching methods. In the switching method, the DNS detection domain name is first acquired. Then, at least according to the acquired DNS detection domain name, it is determined whether the EWAN connection is online. Finally, the Internet access mode of the gateway device is switched to the LTE mode in the case that the EWAN connection is determined to be offline. And the DNS detection domain name is the predefined DNS domain name, and the EWAN connection is the network connection of the gateway device in the EWAN mode. Compared with the related art, whether the Internet access mode is switched to the LTE mode is determined by detecting whether a network cable is plugged into a WAN port, the solution realizes that whether the EWAN connection is online is determined at least according to the acquired DNS detection domain name. That is, at least according to the DNS detection domain name, the EWAN connection established by each IP can be detected, which ensures that whether the EWAN connection is online can be effectively determined, and can more accurately detect whether the EWAN connection in all cases is online. In the case that it is determined that the EWAN connection is offline, the Internet access mode of the gateway device is switched to the LTE mode, so that intelligent switching of the Internet access mode of the gateway device is realized, and the continuity of the terminal user device network is ensured, thereby solving the problem that it is difficult to accurately judge whether the EWAN connection in all cases is online in the related art.

The above is only the preferred embodiments of the present disclosure and is not used to limit the present disclosure. For those skilled in the art, there can be various changes and variations in the present disclosure. Any modifications, equivalent replacements, improvements and the like made within the spirit and principle of the present disclosure shall fall within the scope of protection of the present disclosure.

What is claimed is:

1. A method for switching an Internet access mode of a gateway device, comprising:
acquiring a Domain Name System (DNS) detection domain name, the DNS detection domain name being a predefined domain name;
determining whether an Ethernet Wide Area Network (EWAN) connection is online at least according to the DNS detection domain name, the EWAN connection being a network connection of the gateway device in an EWAN mode; and
switching, in a case that the EWAN connection is offline, the Internet access mode of the gateway device to a Long Term Evolution (LTE) mode.

2. The method as claimed in claim 1, wherein determining whether the EWAN connection is online at least according to the DNS detection domain name comprises:
determining whether connection of dial-up Internet access using at least one of Internet Protocols is offline at least according to the DNS detection domain name; and
determining whether the EWAN connection is offline in a case that the connection of the dial-up Internet access using at least one of the Internet Protocols is offline.

3. The method as claimed in claim 2, wherein determining whether the connection of the dial-up Internet access using at least one of the Internet Protocols is offline at least according to the DNS detection domain name comprises:
sending, based on the Internet Protocol (IP), the DNS detection domain name to a DNS;
determining that the connection of the dial-up Internet access using the IP is online in a case that the DNS detection domain name is resolved in the DNS; and
determining that the connection of the dial-up Internet access using the IP is offline in a case that the DNS detection domain name is not resolved in the DNS.

4. The method as claimed in claim 2, wherein determining whether the connection of the dial-up Internet access using at least one of the Internet Protocols is offline at least according to the DNS detection domain name comprises:
acquiring a preset IP address;
sending, based on the IP, the DNS detection domain name to a DNS;
determining that the connection of the dial-up Internet access using the IP is online in a case that the DNS detection domain name is resolved in the DNS and the preset IP address is reachable; and
determining that the connection of the dial-up Internet access using the IP is offline in a case that at least one of following conditions is met: the DNS detection domain name is not resolved in the DNS, the preset IP address is unreachable.

5. The method as claimed in claim 2, wherein in a case that performing the dial-up Internet access through multiple of the Internet Protocols at the same time, determining whether the EWAN connection is offline in the case that the connection of the dial-up Internet access using at least one of the Internet Protocols is offline comprises:
determining whether the EWAN connection is offline in a case that the connection of the dial-up Internet access using all of the Internet Protocols is offline.

6. The method as claimed in claim 1, after switching the Internet access mode of the gateway device to the LTE mode, further comprising:
sending request information every predetermined time, and determining whether the EWAN connection is online again, the request information being used for requesting connection to the EWAN connection; and
exiting, in a case that the EWAN connection is online, the LTE mode, and switching the Internet access mode of the gateway device to the EWAN mode.

7. The method as claimed in claim 5, wherein determining whether the EWAN connection is online comprises:
determining that the EWAN connection is online in the case that the connection of the dial-up Internet access using at least one of the Internet Protocols is online.

8. A device for switching an Internet access mode of a gateway device, comprising:
an acquisition component, configured to acquire a DNS detection domain name, the DNS detection domain name being a predefined domain name;
a determination component, configured to determine whether an EWAN connection is online at least according to the DNS detection domain name, the EWAN connection being a network connection of the gateway device in an EWAN mode; and
a switching component, configured to switch the Internet access mode of the gateway device to an LTE mode in a case that the EWAN connection is offline.

9. A computer readable storage medium, the computer readable storage medium comprising a program which is stored, wherein the program executes the method as claimed in claim 1.

10. An intelligent switching system, comprising: a gateway device, one or more processors, a memory and one or more programs, wherein the one or more programs are stored in the memory and configured to be executed by the one or more processors, the one or more programs comprising being configured to execute a method for switching an Internet access mode of the gateway device,
the method comprising:
acquiring a DNS detection domain name, the DNS detection domain name being a predefined domain name;
determining whether an EWAN connection is online at least according to the DNS detection domain name, the EWAN connection being a network connection of the gateway device in an EWAN mode; and
switching, in a case that the EWAN connection is offline, the Internet access mode of the gateway device to an LTE mode.

11. The intelligent switching system as claimed in claim 10, wherein determining whether the EWAN connection is online at least according to the DNS detection domain name comprises:
determining whether connection of dial-up Internet access using at least one of Internet Protocols is offline at least according to the DNS detection domain name; and
determining whether the EWAN connection is offline in a case that the connection of the dial-up Internet access using at least one of the Internet Protocols is offline.

12. The intelligent switching system as claimed in claim 11, wherein determining whether the connection of the dial-up Internet access using at least one of the Internet Protocols is offline at least according to the DNS detection domain name comprises:
sending, based on the IP, the DNS detection domain name to a DNS;
determining that the connection of the dial-up Internet access using the IP is online in a case that the DNS detection domain name is resolved in the DNS; and
determining that the connection of the dial-up Internet access using the IP is offline in a case that the DNS detection domain name is not resolved in the DNS.

13. The intelligent switching system as claimed in claim 11, wherein determining whether the connection of the dial-up Internet access using at least one of the Internet Protocols is offline at least according to the DNS detection domain name comprises:
acquiring a preset IP address;
sending, based on the IP, the DNS detection domain name to a DNS;
determining that the connection of the dial-up Internet access using the IP is online in a case that the DNS detection domain name is resolved in the DNS and the preset IP address is reachable; and
determining that the connection of the dial-up Internet access using the IP is offline in a case that at least one of following conditions is met: the DNS detection domain name is not resolved in the DNS, the preset IP address is unreachable.

14. The intelligent switching system as claimed in claim 11, wherein in a case that performing the dial-up Internet access through multiple of the Internet Protocols at the same time, determining whether the EWAN connection is offline in the case that the connection of the dial-up Internet access using at least one of the Internet Protocols is offline comprises:
determining whether the EWAN connection is offline in a case that the connection of the dial-up Internet access using all of the Internet Protocols is offline.

15. The intelligent switching system as claimed in claim 10, after switching the Internet access mode of the gateway device to the LTE mode, further comprising:
sending request information every predetermined time, and determining whether the EWAN connection is online again, the request information being used for requesting connection to the EWAN connection; and
exiting, in a case that the EWAN connection is online, the LTE mode, and switching the Internet access mode of the gateway device to the EWAN mode.

16. The intelligent switching system as claimed in claim 14, wherein determining whether the EWAN connection is online comprises:
determining that the EWAN connection is online in the case that the connection of the dial-up Internet access using at least one of the Internet Protocols is online.

17. The device as claimed in claim 8, the determination component comprises a first determination module and a second determination module, wherein the first determination module is configured to determine whether the connection of dial-up Internet access using at least one of Internet Protocols is offline at least according to the DNS detection domain name; and the second determination module is configured to determine whether the EWAN connection is offline in a case that the connection of the dial-up Internet access using at least one of the Internet Protocols is offline.

18. The device as claimed in claim 17, the first determination module comprises a first sending sub-module, a first determination sub-module and a second determination sub-module, wherein the first sending sub-module is configured to send, based on the IP, the DNS detection domain name to a DNS; the first determination sub-module is configured to determine the connection of the dial-up Internet access using the IP is online in a case that the DNS detection domain name is resolved in the DNS; the second determination sub-module is configured to determine that the connection of the dial-up Internet access using the IP is offline in a case that the DNS detection domain name is not resolved in the DNS.

19. The device as claimed in claim 17, the first determination module comprises an acquisition sub-module, a second sending sub-module, a third determination sub-module and a fourth determination sub-module, wherein the acquisition sub-module is configured to acquire a preset IP address; the second sending sub-module is configured to send, based on the IP, the DNS detection domain name to a DNS; the third determination sub-module is configured to determine that the connection of the dial-up Internet access using the IP is online in a case that the DNS detection domain name is resolved in the DNS and the preset IP address is reachable; the fourth determination sub-module is configured to determine that the connection of the dial-up Internet access using the IP is offline in a case that at least one of following conditions is met: the DNS detection domain name is not resolved in the DNS, the preset IP address is unreachable.

20. The device as claimed in claim 17, the second determination module comprises a fifth determination sub-module, wherein the fifth determination sub-module is configured to determine whether the EWAN connection is offline in a case that performing the dial-up Internet access through multiple of the Internet Protocols at the same time, and in a case that the connection of the dial-up Internet access using all of the Internet Protocols is offline.
